(19) United States
(12) Patent Application Publication
(10) Pub. No.: US 2025/0244118 A1
(43) Pub. Date: Jul. 31, 2025

(54) PIVOT SQUARE PRECISION MEASUREMENT TOOL

(71) Applicant: Timothy Burgess, Myrtle Beach, SC (US)

(72) Inventor: Timothy Burgess, Myrtle Beach, SC (US)

(21) Appl. No.: 18/958,547

(22) Filed: Nov. 25, 2024

Related U.S. Application Data
(60) Provisional application No. 63/625,346, filed on Jan. 26, 2024.

(51) Int. Cl. G01B 3/56; G01C 9/26; G01C 9/34

(52) U.S. Cl. CPC G01B 3/566; G01C 9/26; G01C 9/34

(57) ABSTRACT

A pivot square precision measurement tool having a level device with bubble level disposed with indicia representing linear measurements, and means for attaching another article, instrument, implement, or tool.

### I. RELATED APPLICATIONS

The present application claims priority to U.S. Provisional Patent Application No. 63/625,346, filed on Jan. 26, 2024, the disclosure of which is hereby incorporated by reference in its entirety.

### II. FIELD OF THE INVENTION

The present application discloses and describes a measurement tool, and more particularly, a pivot square precision measurement tool.

### III. BACKGROUND OF THE INVENTION

A number of apparatuses and devices have been developed to provide a better manner by which to install various items, especially in relation to construction and finished carpentry. Although not an exhaustive itemization of those efforts, the following is a representation of the various implements that have been developed:
U.S. Pat. No. 6,049,990, issued in the name of Holland, discloses a layout tool which includes a base having a slotted blade rule disposed within a channel defined in the base, wherein he base further includes a squaring edge end, and wherein the blade rule is slideably disposed within the channel of the base; a vial type bubble level is disposed in a recess on the back of the base;
U.S. Pat. No. 4,955,141, issued in the name of Welch, discloses a reversible adjustable pivot angle square which includes a base blade that contains a reversible level and plumb means rotatably connected to a perpendicular travel blade that contains a reversible level and plumb means in an arrangement that forms an adjustable orthogonal position; moreover, Welch teaches, in relevant part, “ . . . a base blade 20 which has a base blade straight end 44 and a base blade angled end 40 oppositely disposed from base blade straight end 44. The base blade 20 is connected to a travel blade 22 which has a travel blade top end 28 and a travel blade lower end 30 which is oppositely disposed from said travel blade top end 28. The base blade angled end 40 is overlapped by the travel blade lower end 30 and movably connected thereto by passing a base vertex pin 58 through a base vertex pin aperture 46 and a common axis travel blade vertex pin aperture 48 and securing with a base vertex pin fastener 59. The base vertex pin 58 comprises a shoulder threaded slot head bolt appropriately sized and externally threaded to allow the base blade 20 and the travel blade 22 to rotate freely on axis of the shouldered section of the threaded bolt.” (See Col. 8, lines 35-51);
U.S. Pat. No. 10,239,200 B2, issued in the name of Pepper, discloses a roof square for marking rafters comprising a right angle triangular body with a marking blade pivotally mounted adjacent the right angle, either side of the square adjacent the right angle is held against the stock to be marked, and the blade used to mark either a plumb cut or a foot cut, and wherein the blade retracts to allow marks to be made at a measured depth, and wherein the tool can also be used as a conventional square to make 90 and 45 degree marks;
U.S. Pat. No. 4,348,815, issued in the name of Hurt, discloses a pair of first and second elongated arms that are provided and the arms include corresponding base and free ends, and includes a pivot structure is provided and pivotally connects the base ends of the arms together for relative 360° angular displacement and the pivot structure and second arm include coacting structure whereby the axis of relative pivoting of the first and second arms may be adjustably shifted along the second arm;
U.S. Pat. No. 11,555,682 B2, issued in the name of Turley, discloses adjustable square has a blade including a scale, a body, a slot formed in the body for movably receiving the blade, a locking mechanism operably engaged with the body for releasably securing the blade within the slot, and an indexing member operably engaged with the body and operably engaged with the blade, wherein the indexing member indexes the body at precise locations along the blade;
U.S. Pat. No. 5,446,969, issued in the name of Terenzoni, discloses a combination square and multi-purpose hand tool can be utilized as a large number of hand tools including a square, bevel square, stud and ceiling strapping spacer, clamp, caliper, string tender, and scribe, the tool having a first L shaped member includes a blade portion and a handle portion, and a second member is pivotably and slidably coupled to the blade portion of the first member, wherein the individual member dimensions such as the overall length of the first member, the maximum extended length of the second member along the first member, and the width of the blade portion of the first member are pre-established at selected lengths and widths, to provide predetermined functions for the present multi-purpose hand tool such as a stud spacer, ceiling strapping spacer and string tender; and
U.S. Pat. No. 981,867, issued in the name of McCormick, discloses a square and relates to a bevel provided with tables whereby, when the width of a building is known and the rise per foot of the rafters is given, the length of the rafters and the angle at which the ends of said rafters are to be cut, may be readily ascertained.

Accordingly, there is a need for an apparatus, system, and/or method that provides a new pivot square apparatus or device with precision measuring capabilities.

This application presents claims and embodiments that fulfill a need or needs not yet satisfied by the products, inventions, systems, and methods previously or presently available. In particular, the claims and embodiments disclosed herein describe a pivot square precision measurement tool, the tool comprises a level device, the level device comprises a bubble level, the level device is disposed with ruler markings; and at least one pivot square, the at least one pivot square is detachably securable via a coupling means to an upper side, bottom side, or front side of the level device, thereby enabling the at least one pivot square to be positioned atop the upper side, bottom side, or front side of the level device at a selectively-desired position therealong, the tool providing unanticipated and nonobvious combination of features distinguished from the products, devices, apparatuses, inventions, systems, and methods preexisting in the art. The applicant is unaware of any device, apparatus, method, system disclosure or reference that discloses the features of the claims and embodiments disclosed herein.

### IV. SUMMARY OF THE INVENTION

Generally, according to a broadly described embodiment, a pivot square precision measure tool is disclosed. The tool 10 comprises a body comprising a geometrically-shaped configuration. Most preferably, the body comprises a rectangular cuboid-shaped configuration. The rectangular cuboid body comprises a front surface opposing a rear surface, a top surface opposing a bottom surface, and a right lateral surface and a left lateral surface. The front surface is bound by the top surface along a top margin, by the bottom surface along a bottom margin, by the right lateral surface along a right lateral margin, and by the left lateral surface along a left lateral margin; similarly, the rear surface is bound by the top surface along a top margin, by the bottom surface along a bottom margin, by the right lateral surface along a right lateral margin, and by the left lateral surface along a left lateral margin.

The body further comprises at least one bubble level indicator. In accordance to another embodiment, it is envisioned that the body comprises three bubble level indicators, wherein the level indicators assist in identifying orientation relative to 90 degrees, 180 degrees, and 45 degrees. In one such embodiment of the indicators, each of the three bubble level indicators is visible through the front surface and the rear surface of the rectangular cuboid body. In another such embodiment of the bubble level indicators, each of the three bubble level indicators is visible through either the front surface or the rear surface. It is also envisioned that one or more bubble level indicators may be disposed in multiple surfaces of the rectangular cuboid body.

The body still further comprises indicia for measuring length, such as including, but not limited to, imperial units, metric units, and a combination of imperial and metric units.

The indicia may comprise one or more series or arrays delineating different lengths and units. It is envisioned that indicia may comprise a single array of length and may include one or multiple units (including combinations of imperial and metric units, and degree measures). Depending upon the length of the single array, the indicia may be disposed along the longest side(s) of surfaces or other surfaces.

Alternatively, indicia may comprise multiple series or arrays, including identical lengths and units or variable lengths and variable units, and combinations thereof. Such embodiment(s) of indicia may be disposed along various positions of the front and or rear surfaces, and/or other surfaces.

The tool may comprise a means for attaching and removing articles or instruments to the body. As depicted, the article is a square. The means may be disposed along one or more surfaces of the body. The means may include a single or multiple slot(s), wherein the slot(s) may accommodate various fasteners such as screws and/or bolts that may be secured and temporarily fixed into position with a nut, nut and washer, wingnut, wingnut and washer, and/or other similar mechanism for fixing the fastener into a specified location and position. The means may also include one or more strands of hook and/or loop material. It is further envisioned that the tool may include slot(s) and hook/loop material 18b in combination.

The level (as incorporated into the body) and square may be modified to accommodate each other and function as one tool or when separated from each other function as independent tools. The tool would be able to accept a number of attachments including but not limited to a square, a pivoting square, tabs and lasers. And, with the appropriate attachments the tool may be used to layout rafters, determine the pitch of an existing roof, hanging pictures, used as a story pole with multiple elevations, used for the layout of shelves, and to layout horizonal and vertical parallel lines.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a front view of the tool;

FIG. 2a is a rear view of the tool;

FIG. 2b is a rear view of the tool and an alternative to FIG. 2a;

FIG. 3 is a front view of the tool with a slot and multiple indicia;

FIG. 4 is a front view of the tool with hook/loop material and multiple indicia;

FIG. 5a and FIG. 5b each is a front view of the tool with hook/loop material for securing the square to the body of tool;

FIG. 6a and FIG. 6b each is a front view of the tool with a slot for securing the square to the body of the tool using a fastener and wingnut;

FIG. 7a is a front view of the tool, in accordance to another embodiment of the present invention;

FIG. 7b is a partial bottom view of the tool depicted in FIG. 7a illustrating an adjustment mechanism;

FIG. 7c is a partial bottom view of the tool depicted in FIG. 7a illustrating the terminal end of the housing;

FIG. 7d is a perspective view of a conventional picture frame;

FIG. 8a is a front view of the tool, in accordance to another embodiment of the present invention;

FIG. 8b is an enlarged, partial front view of the tool depicted in FIG. 8a;

FIG. 8c is an enlarged, partial rear view of the tool illustrated in FIG. 8a;

FIG. 9a is a front view of the tool, in accordance to another embodiment of the present invention;

FIG. 9b is a rear view of the tool in FIG. 9a;

FIG. 9c is a front view of the tool of FIG. 9a, wherein the square thereof is shown pivoted in a different angular orientation;

FIG. 10a is a front view of the tool, in accordance to another embodiment of the present invention;

FIG. 10b is a rear view of the tool in FIG. 10a;

FIG. 10c is a front view of a brace and of the tool, in accordance to one embodiment of the present invention;

FIG. 10d is an outer side elevational view of the brace of FIG. 10c;

FIG. 10e is an inner side view of the brace of FIG. 10c; and

FIG. 10f is a front view of the tool depicting a picture frame braced between a pair of squares.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

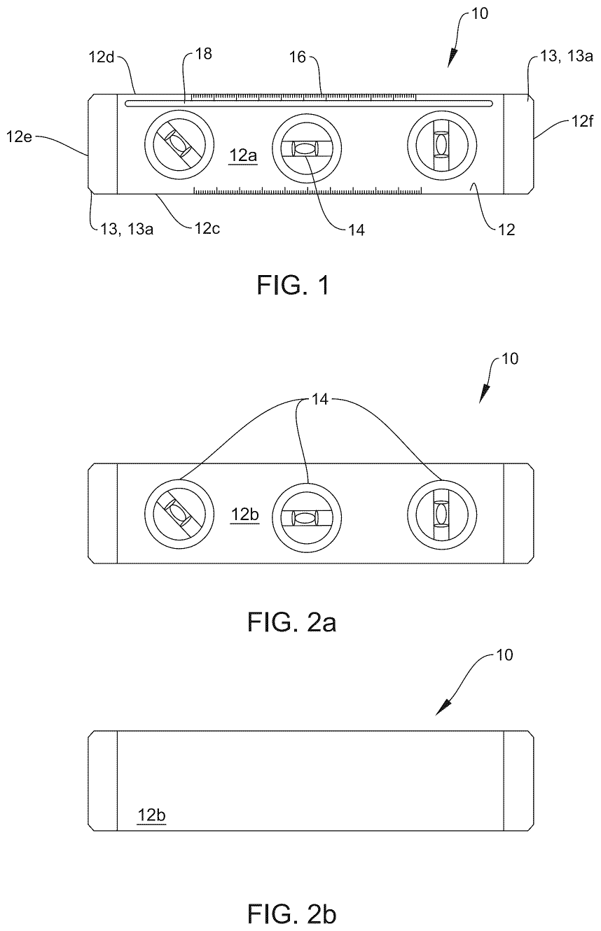

According to at least one embodiment, and consistent with FIGS. 1-6b, a pivot square precision measure tool is generally denoted by the reference character 10. Consistent with the figures, the tool 10 comprises a hexahedron body 12. Preferably, the body 12 comprises a convex hexahedron; more preferably, the body 12 comprises a cuboid; and most preferably, the body 12 comprises a rectangular cuboid. In particular, as illustrated in the figures, the body 12 comprises a rectangular cuboid comprising a front surface 12a opposing a rear surface 12b, a top surface 12c opposing a bottom surface 12d, and a right lateral surface 12e and a left lateral surface 12f. The front surface 12a is bound by the top surface 12c along a top margin, by the bottom surface 12d along a bottom margin, by the right lateral surface 12e along a right lateral margin, and by the left lateral surface 12f along a left lateral margin; similarly, the rear surface 12b is bound by the top surface 12c along a top margin, by the bottom surface 12d along a bottom margin, by the right lateral surface 12e along a right lateral margin, and by the left lateral surface 12f along a left lateral margin. It is also envisioned (and as illustrated) that each of the upstanding vertices 13 (four vertices in number) defining the edges traversing between the front surface 12a and the rear surface 12b define an angle 13a.

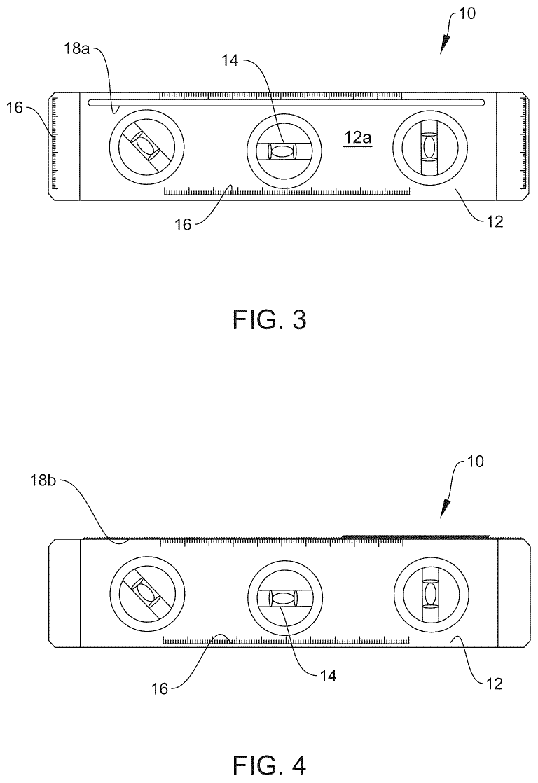

As depicted in FIG. 1, FIG. 2a, and FIGS. 3 through FIG. 6b, the body 12 comprises at least one bubble level indicator 14. In one embodiment, it is envisioned that the body 12 comprises three bubble level indicators 14, wherein the level indicators 14 assists in identifying orientation relative to 90 degrees, 180 degrees, and 45 degrees. In one such embodiment of the indicators 14, consistent with FIG. 1 and FIG. 2a, each of the three bubble level indicators 14 is visible through the front surface 12a and the rear surface 12b. In another such embodiment of the bubble level indicators 14, each of the three bubble level indicators 14 is visible through either the front surface 12a or the rear surface 12b. It is also envisioned that one or more bubble level indicators 14 may be disposed in multiple surfaces 12a-12f of body 12.

Consistent with FIG. 1, FIG. 3, and FIG. 4, the body 12 also comprises indicia 16 for measuring length. In one embodiment, the indicia 16 comprises imperial units. In an alternate embodiment, the indicia 16 comprises metric units. In another embodiment, the indicia 16 comprises a combination of imperial and metric units.

Indicia 16 may comprise one or more series or arrays delineating different lengths and units. It is envisioned that indicia 16 may comprise a single array of length and may include one or multiple units (including combinations of imperial and metric units). Depending upon the length of the single array, the indicia 16 may be disposed along the longest side(s) of surfaces 12a and/or 12b and/or 12c and/or 12d and/or 12e and/or 12f. Alternatively, indicia 16 may comprise multiple series or arrays, including identical lengths and units or variable lengths and variable units, and combinations thereof. Such embodiment(s) of indicia 16 may be disposed along various positions of surfaces 12a and/or 12b and/or 12c and/or 12d and/or 12e and/or 12f.

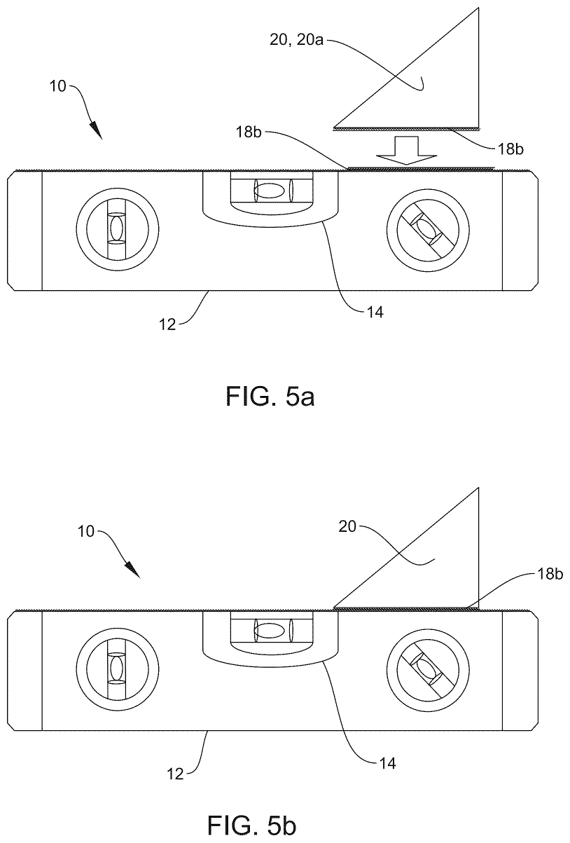

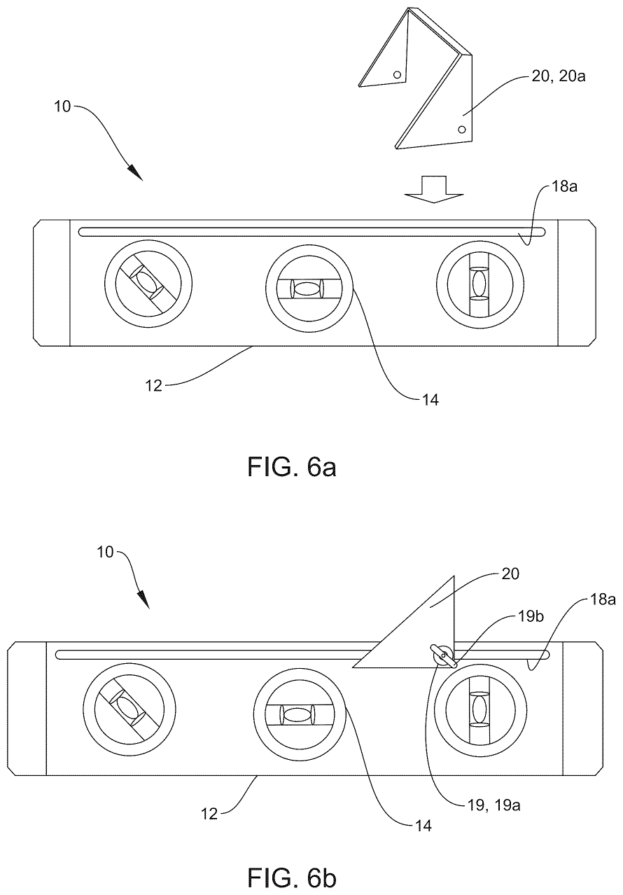

Consistent with FIG. 3, FIG. 4, FIG. 5a, FIG. 5b, FIG. 6a, and FIG. 6b, tool 10 may comprise means 18 for attaching and removing articles or instruments 20 to the body 12. As depicted, the instrument 20 is a square 20a. Means 18 may be disposed along one or more surfaces 12a and/or 12b and/or 12c and/or 12d and/or 12e and/or 12f. Means 18 may include a single or multiple slot(s) 18a, wherein the slot(s) 18a may accommodate various fasteners 19 such as screws and/or bolts 19a that may be secured and temporarily fixed into position with a nut, nut and washer, wingnut, wingnut and washer 19b, and/or other similar mechanism for fixing the fastener 19 into a specified location and position. The fastener 19 enables the square 20a to pivot and slidably engage the slot 18a in a reciprocating fashion until a desired position along the slot 18a is obtained by the user. Once a position has been selected by user, the user secures the square 20a in the selected position by screwing a wingnut and washer 19b onto the fastener 19 (bolt 19a) until taut. Means 18 may also include one or more strands of hook and/or loop fastener material 18b. In accordance to one exemplary embodiment depicted in FIGS. 5a and 5b, a lower surface of the square 20a includes hook or loop fastener material 18b coupled to complementary hook or loop fastener material 18b disposed along the bottom surface 12d of the tool 10. It is further envisioned that the tool 10 may include slot(s) 18a and hook and/or loop fastener material 18b in combination.

As depicted, the level 14 (as incorporated into body 12) and square 20 may be modified to accommodate each other and function as one tool or when separated from each other function as independent tools. The tool 10 would be able to accept a number of attachments including but not limited to a square, a pivoting square, tabs and lasers. And, with the appropriate attachments the tool 10 may be used to layout rafters, determine the pitch of an existing roof, hanging pictures, used as a story pole with multiple elevations, used for the layout of shelves, and to layout horizonal and vertical parallel lines.

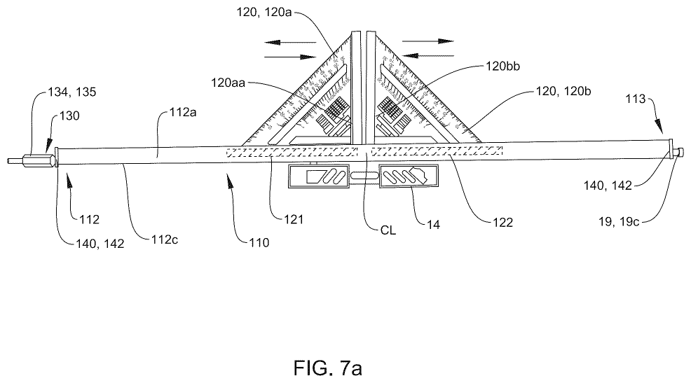

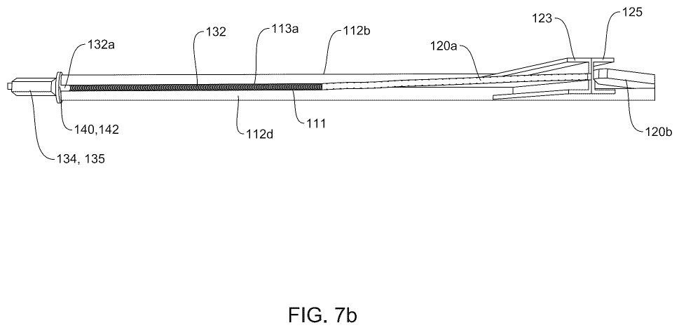

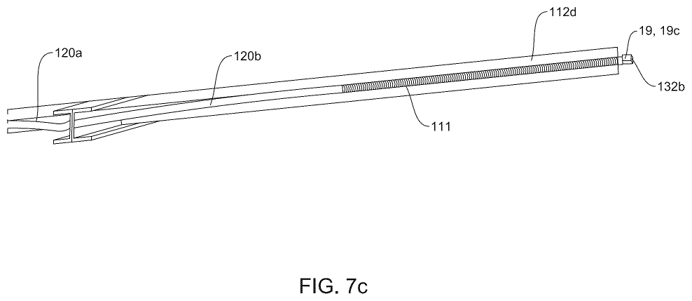

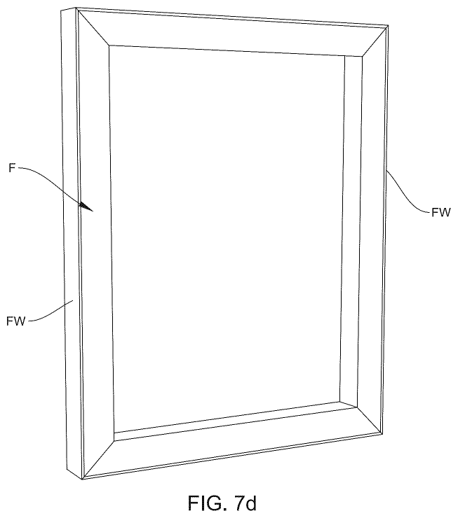

Referring now to FIGS. 7a-7d, in accordance to another embodiment of the present invention, a pivot square precision measure tool, hereinafter referred to as tool, is generally denoted by the reference character 100. The tool 100 comprises a linearly-elongated housing 110 having a primary end 112 opposing a terminal end 113, and a hollow interior 113a. Both the primary end 112 and the terminal end 113 are open. The tool 100 further comprises a front surface 112a opposing a rear surface 112b, and a top surface 112c opposing a bottom surface 112d. A slot 111 is defined in the bottom surface 112d of housing 110 and extends an entire length theredown. The slot 111 is in open, fluid communication with the hollow interior 113a.

At least one bubble level indicator 14 is mounted to the top surface 112c of housing 110. Three bubble level indicators 14 are depicted in the embodiment shown in FIGS. 7a-7c.

The tool 100 further comprises an adjustment mechanism 130 disposed within the hollow interior 113a, wherein the adjustment mechanism 130 enabling a pair of instruments 120 to reciprocate along the slot 111 of housing 110. The adjustment mechanism 130 comprises an elongated threaded axle 132 and adjustment control 134. The adjustment control 134 is mounted to a first end 132a of the threaded axle 132. The threaded axle 132 extends axially from the primary end 112 to the terminal end 113 of the housing 110 and a fastener 19, such as one or more bolts 19c, secured to the second end 132b of the threaded axle 132. The adjustment control 134 comprises a turnable knob 135.

A guard 140, such as a washer 142, is positioned contiguous to the primary end 112 of housing 110, thereby preventing the knob from being drawn into the primary end 112, and preventing the threaded axle 132 from being ejected through the terminal end 113 of the housing 110. Another guard 140, such as a washer 142, is positioned contiguous to the terminal end 113 of housing 110, thereby preventing the second end 132b of the threaded axle 132 from being drawn into the terminal end 113 of the housing 110, and preventing the threaded axle 132 from being ejected from the primary end 112 of the housing 110.

A pair of instruments 120, shown herein as a first square 120a and a second square 120b, is movably connected to the adjustment mechanism 130 in an appositional orientation. The first square 120a and the second square 120b each includes a vertical frame wall brace 123 and 125, respectively. Vertical frame wall brace 123 is coupled to the vertical side edge 120aa of the first square 120a, and vertical frame wall brace 125 is coupled to the vertical side edge 120bb of the second square 120b. Each the first square 120a and the second square 120b comprises a threaded aperture 121 and 122 respectively, defined through and extending lengthwise along respective bottom edges thereof. The threaded axle 132 threadedly engages and is advanced through the threaded aperture 121 of first square 120a and through threaded aperture 122 of the second square 120b. The first square 120a and second square 120b upwardly depend from the threaded axle 132 and through the slot 112 of housing 110.

In accordance to one embodiment, turning the knob 135 in a counter-clockwise direction causes the first square 120a and the second square 120b to diverge simultaneously along the threaded axle 132. More specifically, when rotating the knob 135 counter-clockwise, in a simultaneous manner, the first square 120a moves toward the primary end 112 of housing 110 and the second square 120b moves toward the terminal end 113 of housing 110. Conversely, turning the knob 135 in a clockwise direction causes the first square 120a and the second square 120b to converge simultaneously along the threaded axle 132. More specifically, when rotating the knob 135 clockwise, the first square 120a and the second square 120b converge about the threaded axle 132 in a simultaneous manner in a direction towards a centerline CL of the housing 110.

Turning the knob 135 in a clockwise direction causes the first square 120a and the second square 120b to converge about the threaded axle 132 in a simultaneous manner, thereby enabling the wall braces 123 and 124 of the first square 120a and the second square 120b, respectively, to abut opposing external longitudinal frame walls FW of a picture frame F in a flush manner.

Other mechanical means are contemplated for directing the first square 120a and the second square 120b to both diverge and converge along the slot 111 of the housing 110, and therefore, said mechanical means are within the spirit and scope of the present application.

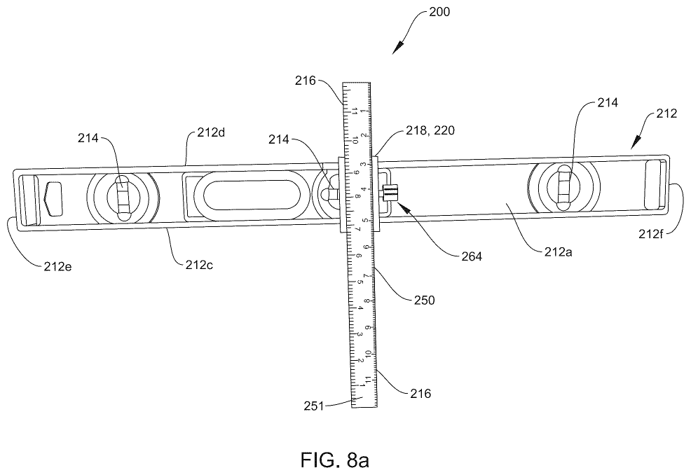

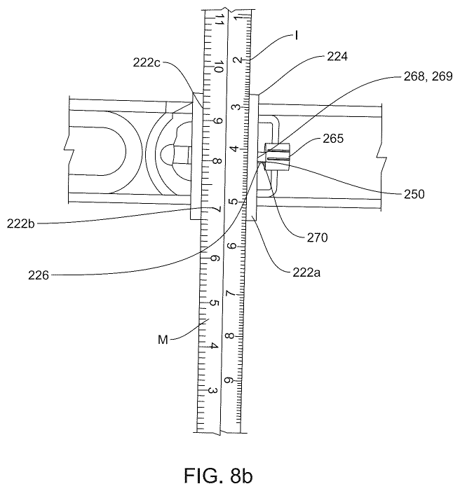

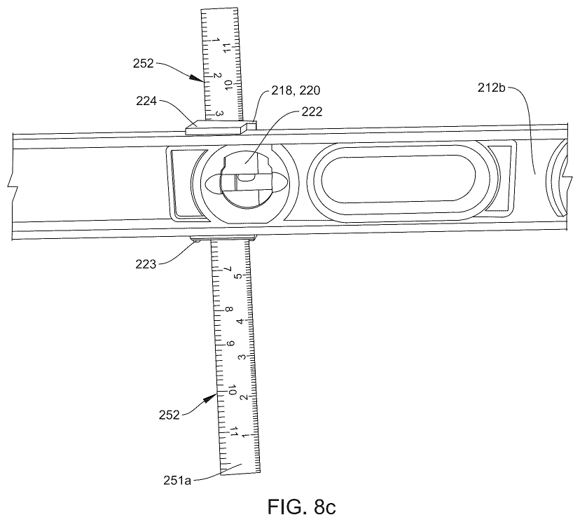

Referring now to FIGS. 8a-8c, in accordance to another embodiment of the present invention, a pivot square precision measure tool, hereinafter referred to as tool, is generally denoted by the reference character 200. The tool 200 comprises an elongated body 212 comprising a front surface 212a opposing a rear surface 212b, a top surface 212c opposing a bottom surface 212d, and a right lateral surface 212e and a left lateral surface 212f. The front surface 212a is bound by the top surface 212c along a top margin, by the bottom surface 212d along a bottom margin, by the right lateral surface 212e along a right lateral margin, and by the left lateral surface 212f along a left lateral margin; similarly, the rear surface 212b is bound by the top surface 212c along a top margin, by the bottom surface 212d along a bottom margin, by the right lateral surface 212e along a right lateral margin, and by the left lateral surface 212f along a left lateral margin.

The body 212 comprises at least one bubble level indicator 214 disposed therein. In one embodiment depicted in FIG. 8a, the body 212 comprises three bubble level indicators 214.

The tool 200 may comprise means 218 for attaching and removing additional articles, instruments 20, or abutments 220 to the body 212. According to one exemplary embodiment, the body 212 is constructed of a ferromagnetic material. The means 218 may be disposed along at least one of surfaces 212a, 212b, 212c and/or 212d and/or 212e and/or 212f. In accordance to one exemplary embodiment, means 218 comprises an abutment 220 comprising a front wall 222 and a pair of transverse walls 223 and 224 integrally extending perpendicularly from an upper end and a lower end, respectively, of the front wall 222. A magnet 222c is disposed within a recess 222b integrally formed within the front surface 212a of the body 212, thereby enabling the abutment 220 to be removably attached superjacent the front surface 212a of the body 212. A linearly-elongated ferromagnetic scroll plate 250 is removably attached longitudinally superjacent a front surface 222a of the magnetic front wall 222.

The scroll plate 250 comprises indicia 216 for measuring length. In one embodiment, the indicia 216 comprises at least one of imperial units I and metric units M. The indicia 216 is disposed along an upper surface 251 and a lower surface 251a of the linearly-elongated scroll plate 250. In view of the scroll plate 250 being constructed of a ferromagnetic metal, the scroll plate 250 is removably attachable superjacent the front surface 212a of the body 212.

The scroll plate 250 further comprises a series of substantially closely-aligned grooves 252 defined along at least one of the upper surface 251 and the lower surface 251a of scroll plate 250 for threaded engagement by a key 264 of the abutment 220. In accordance to the embodiment depicted in FIG. 8c, the grooves 252 are provided on the lower surface 251a of the scroll plate 250. The key 264 comprises a turnable knob 265 and a sprocket 268 comprising teeth 269, wherein the knob 265 is secured to the sprocket 268 via a pin 270. The pin 270 extends through a hole 225 defined perpendicularly through the transverse wall 224 of abutment 220. The sprocket 268 is seated within a slot 226 defined in the front wall 222 of abutment 220. Rotation or turning of the key 264 in either a clockwise or counterclockwise direction causes the teeth 269 of the sprocket 268 to mesh with or threadedly engage the grooves 252 of scroll plate 250, thereby allowing for selective, incremental vertical adjustment of the scroll plate 250 relative to the elongated body 212 of the tool 200 by the user. The tool 200 is adapted and configured to enable a single user to make a plumb cut for a selectively-desired pitched roof measure. For purposes of this disclosure, the term “plumb cut” is intended to mean a cut in a vertical plane; more specifically, the top cut face of a rafter that is designed to butt vertically against a ridgeboard. Thus, a plumb cut is a vertical cut in a rafter or other sloped framing element that will properly align the cut item with a plumb wall.

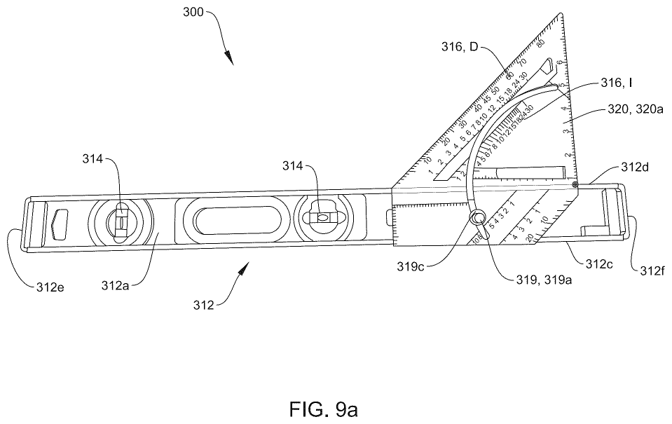

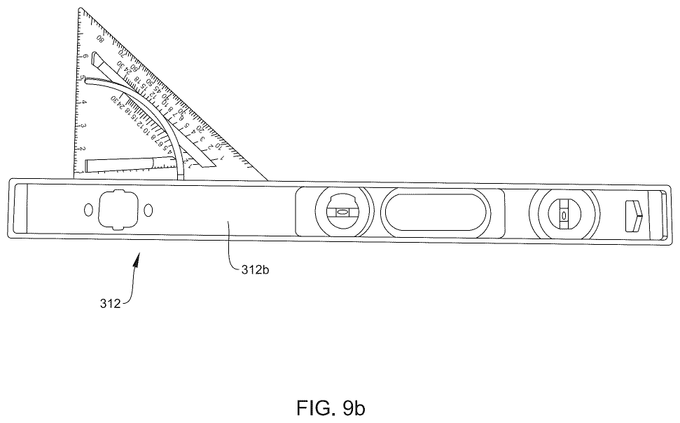

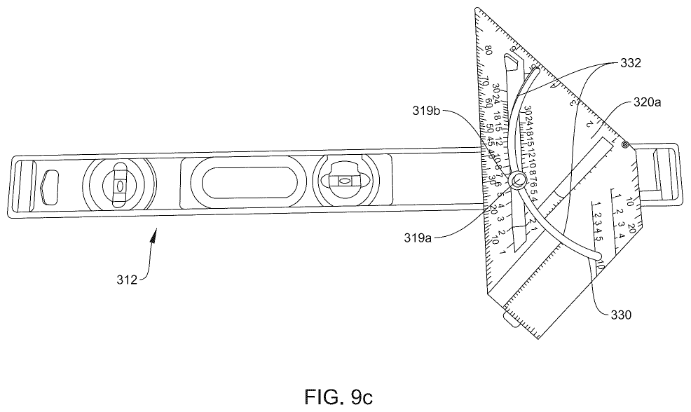

Referring now to FIGS. 9a-9c, in accordance to another embodiment of the present invention, a pivot square precision measure tool, hereinafter referred to as tool, is generally denoted by the reference character 300. The tool 300 comprises an elongated body 312 comprising a front surface 312a opposing a rear surface 312b, a top surface 312c opposing a bottom surface 312d, and a right lateral surface 312e and a left lateral surface 312f. The front surface 312a is bound by the top surface 312c along a top margin, by the bottom surface 312d along a bottom margin, by the right lateral surface 312e along a right lateral margin, and by the left lateral surface 312f along a left lateral margin; similarly, the rear surface 312b is bound by the top surface 312c along a top margin, by the bottom surface 312d along a bottom margin, by the right lateral surface 312e along a right lateral margin, and by the left lateral surface 312f along a left lateral margin.

The body 312 comprises at least one bubble level indicator 314. In one embodiment depicted in FIGS. 9a-9c, the body 312 comprises two bubble level indicators 314.

The tool 300 further comprises an instrument 320 comprising a square 320a pivotally secured to the front surface 312a of the body 312 via a fastener 319, such as a threaded bolt 319a and washer 319b. The square 320a comprises an arcuate-shaped slot 330 defined therethrough. The threaded bolt 319a extends through the slot 330 and threadedly engages a threaded bore 319c defined perpendicularly in the front surface 312a of body 312. The threaded bolt 319a functions as a pivot axis about which the square 320a pivots and slidably engages the slot 330 of the square 320a. The washer 319b slidably engages a peripheral edge 332 of the slot 330. When a desired pivotal position regarding the square 320a is selected by user, the square 320a is secured in such position by tightening threaded bolt 319a until taut. To change the securably-set position of square 320a, user simply loosens the threaded bolt 319a and pivots square 320a the about threaded bolt 319a along the slot 330. FIG. 9a illustrates the square 320a oriented in a selected position, and FIG. 9c depicts the square 320a having been pivoted to an alternative pivotal position.

The square 320a further comprises indicia 316 for obtaining measurements. In one embodiment, the indicia 316 comprises at least one of imperial units I, metric units M, and degree measures D.

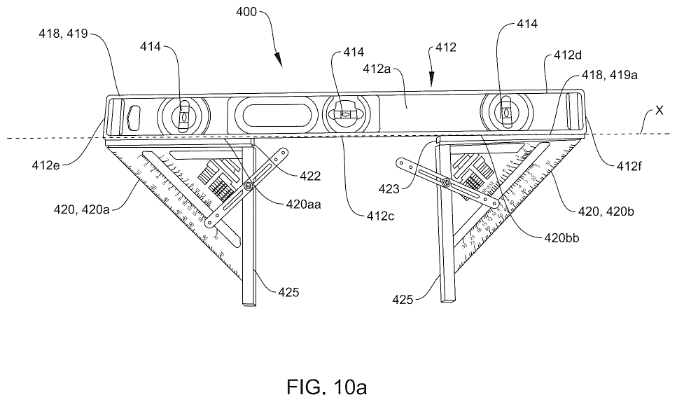

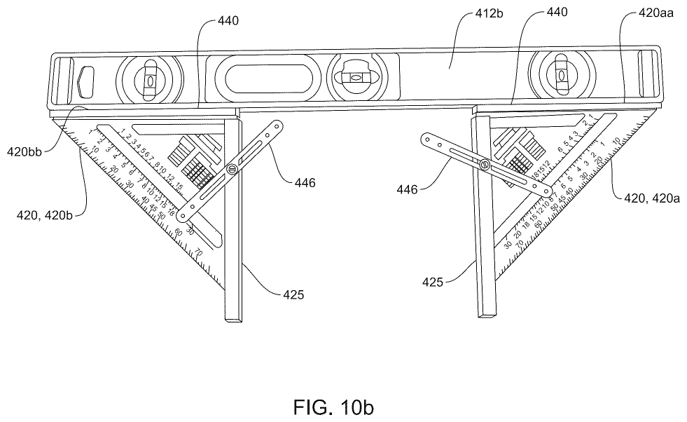

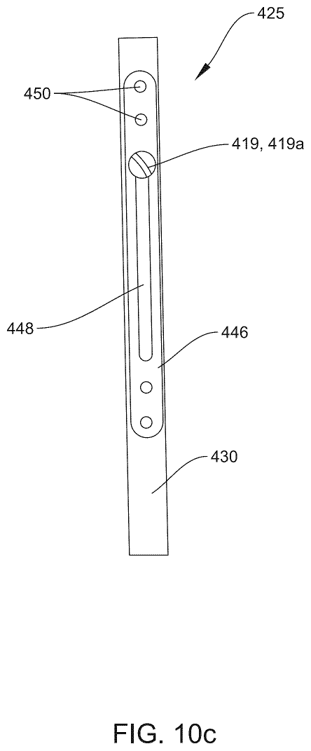

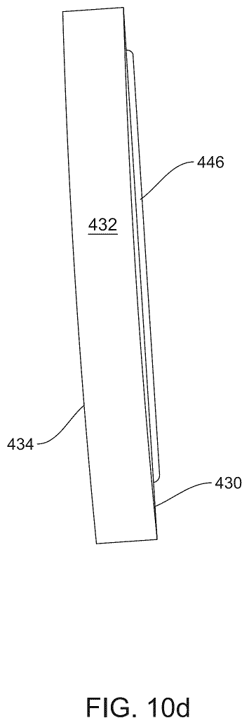

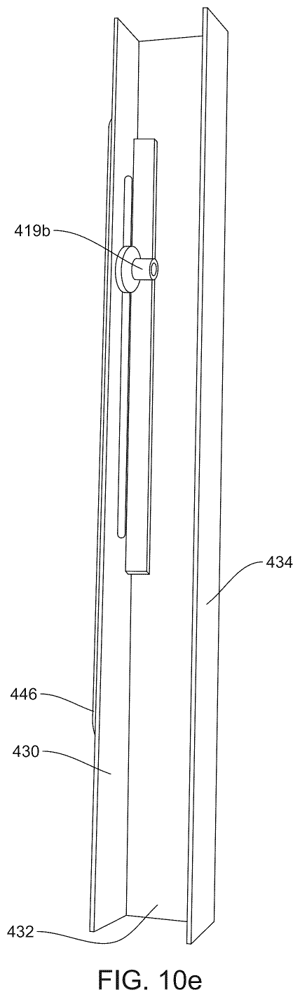

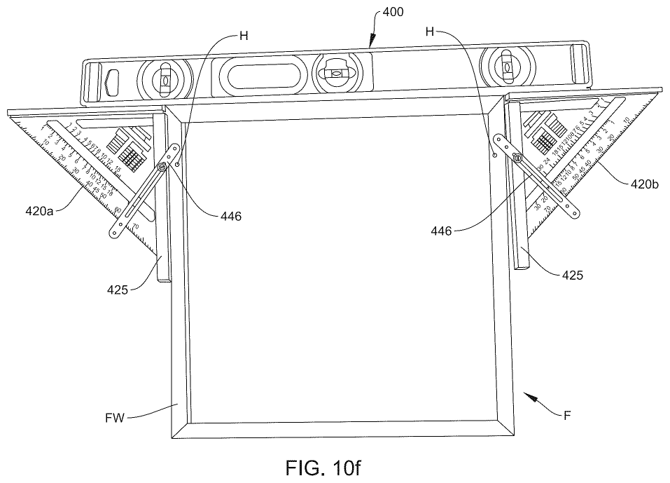

Finally, in reference to FIGS. 10a-10f, in accordance to another embodiment of the present invention, a pivot square precision measure tool, hereinafter referred to as tool, is generally denoted by the reference character 400. The tool 400 comprises an elongated body 412 comprising a front surface 412a opposing a rear surface 412b, a top surface 412c opposing a bottom surface 412d, and a right lateral surface 412e and a left lateral surface 412f. The front surface 412a is bound by the top surface 412c along a top margin, by the bottom surface 412d along a bottom margin, by the right lateral surface 412e along a right lateral margin, and by the left lateral surface 412f along a left lateral margin; similarly, the rear surface 412b is bound by the top surface 412c along a top margin, by the bottom surface 412d along a bottom margin, by the right lateral surface 412e along a right lateral margin, and by the left lateral surface 412f along a left lateral margin.

The body 412 comprises at least one bubble level indicator 414. In one embodiment depicted in FIGS. 10a, 10b, and 10f, the body 412 comprises three bubble level indicators 414.

The tool 400 may comprise means 418 for attaching and removing additional articles, or instruments 420 to the body 412. In accordance to the embodiment illustrated in FIGS. 10a, 10b, and 10f, the instrument 420 comprises a first square 420a and a second square 420b. Each the first square 420a and the second square 420b comprises indicia 416 for obtaining measurements. In one embodiment, the indicia 416 comprises at least one of imperial units I, metric units M, and degree measures D.

The means 418 may be disposed along at least one of surfaces 412a, 412b, 412c and/or 412d and/or 412e and/or 412f. In accordance to one exemplary embodiment, means 418 comprises a first planar magnetic plate 419 mounted superjacent the top surface 412c of the body 412, and a second planar magnetic plate 419a mounted superjacent the top surface 412c of body 412 and spaced distal to the first planar plate 419.

A planar plate 440, or flexible strip, segment or layer, constructed of a ferromagnetic metal is coupled to a lower surface 420aa and 420bb of each the first square 420a and the second square 420b, respectively. The ferromagnetic plates 440 enable the first square 420a and a second square 420b to be removably attached and positioned along respective magnetic plates 419 and 419a about a plurality of selectively-desired lateral positions.

The tool 400 further comprises a brace 425 mounted to a longitudinal side edge 422, 423 of each the first square 420a and the second square 420b, respectively. The brace 425 comprises a generally C-shaped configuration. Each square 420a and 420b is movable laterally, inwardly and outwardly (or otherwise in a reciprocating fashion), about the first magnetic plate 419 and second magnetic plate 419a, respectively, along horizontal axis X such that the brace 425 of each square 420a and 420b engages opposing external longitudinal frame walls FW of a picture frame F in a flush manner, as depicted in FIG. 10f.

Other means 418, such as hook-and-loop fastener material, for attaching and removing additional articles, or instruments 420 to the body 412, are contemplated and therefore within the spirit and scope of the present application.

The brace 425 of each square 420a and 420b comprises a front wall 430 opposing a rear wall 434 and a side wall 432 integrally joining the front wall 430 and rear wall 434. The brace 425 of each square 420a and 420b further comprises an alignment arm 446 pivotally coupled to the brace 425 via a fastener 419, such as a screw 419a, threadedly engaging a threaded receiver 419b. The alignment arm 446 includes an elongated slot 448 defined therein, wherein the fastener 419 functions as a pivot axis about which the alignment arm 446 both pivots and slidably engages in a reciprocating fashion. The alignment arm 446 is pivotable 360° about the fastener 419.

The alignment arm 446 further includes at least one alignment aperture 450 defined in at least one end thereof. The alignment arm 446 is adapted and configured to pivot and slide about fastener 419 via the elongated slot 448 and axially align the at least one alignment aperture 450 with a frame mounting hole H defined in the longitudinal frame wall FW of a picture frame F, and thereafter user tightens the fastener 419 securing the alignment arm 446 of each square 420a and 420b in a selectively-desired, detachably secured position (see FIG. 10f). The set position of the at least one alignment aperture 450 each alignment arm 446 provides the precise points at which mounting hardware, such as screws and anchors, wall hooks, cleat hangers, bear claw screws, nails, and the like, may be hammered or driven into a picture frame mounting surface, such as a wall.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A pivot square precision measurement tool, the tool comprises:
a level device with a bubble level, the level device is disposed with ruler markings and a horizontally-elongated travel slot defined therethrough, wherein the tool further comprises at least one pivot square being pivotally and slidably adjustable between opposed ends of the level device, and releasably secured position along the at a selectively-desired horizontal horizontally-elongated slot defined in the level device via a travel pivot lock mechanism received through the horizontally-elongated travel slot.

2. A pivot square precision measurement tool, the tool comprises:
an elongated body comprising a front surface opposing a rear surface, a top surface opposing a bottom surface, and a right lateral surface and a left lateral surface, the body comprising at least one bubble level indicator; and
at least one square pivotally secured to the front surface of the body via a fastener.

3. The pivot square precision measurement tool of claim 2, wherein the square comprises an arcuate-shaped slot defined therethrough, the fastener extends through the slot and threadedly engages a threaded bore defined perpendicularly in the front surface of the body, wherein the fastener functions as a pivot axis about which the square pivots and slidably engages the slot of the square, thereby enabling the square to be positioned and removably secured at a selectively-desired pivotal position along the front surface of the body.

4. The pivot square precision measurement tool of claim 3, wherein the square further comprises indicia for obtaining measurements.

5. The pivot square precision measurement tool of claim 4, wherein, the indicia comprises at least one of imperial units, metric units, and degree measures.

6. A pivot square precision measurement tool, the tool comprising:
a cuboid body having a front surface opposing a rear surface, a top surface opposing a bottom surface, and right lateral surface opposing a left lateral surface, the front surface and the rear surface spaced apart by a width of the top surface and opposing bottom surface and by a width of a right lateral margin and opposing left lateral margin;
at least one bubble level indicator formed in one of the surfaces of the cuboid body;
at least one array of indicia formed on one of the surfaces of the cuboid body; and
means for attaching an article to the cuboid body of the tool.
